(19) United States
(12) Patent Application Publication
(10) Pub. No.: US 2026/0168262 A1
(43) Pub. Date: Jun. 18, 2026

(54) FILM FOR FORMING A PLATE MATERIAL, AND PLATE MATERIAL

(71) Applicant: Profol GmbH, Halfing (DE)

(72) Inventor: Maximilian PRASSBERGER, Halfing (DE)

(21) Appl. No.: 19/401,104

(22) Filed: Nov. 25, 2025

(30) Foreign Application Priority Data
Nov. 26, 2024 (DE) 10 2024 134 777.5

(51) Int. Cl. E04F 15/10; B32B 3/30; B32B 9/00; B32B 9/04; B32B 21/08; B32B 25/08; B32B 27/20; B32B 27/32

(52) U.S. Cl. CPC E04F 15/107; B32B 3/30; B32B 9/002; B32B 9/045; B32B 21/08; B32B 25/08; B32B 27/20; B32B 27/32; B32B 2250/05; B32B 2264/102; B32B 2264/303; B32B 2307/7376; B32B 2471/00

(57) ABSTRACT

Film for forming a plate material with a structured surface by applying the film to a decorative substrate, wherein the film comprises: a wear protection group, comprising a connection layer which is designed to be connected to a decorative layer or decorative layer group, a transparent base layer on the connection layer, and a surface layer on the transparent base layer; a first lacquer layer on the surface layer of the wear protection group, wherein the first lacquer layer comprises an admixture of solid particles; and a second lacquer layer on the first lacquer layer, wherein the second lacquer layer comprises an admixture of silica particles.

### TECHNICAL FIELD

The present invention relates to a film for forming a plate material by applying the film to a decorative substrate, in particular made of a material that is stiffer compared with the film. The invention furthermore relates to a plate material of this kind, in particular a flooring element.

### TECHNICAL BACKGROUND

Plate materials are widely used as building, furnishing, decorative and construction material. In this case, such plate materials are often provided in the form of so-called laminates, in which a laminate layer covers a substrate. In this case, the laminate layer provides the desired appearance and the desired properties of the surface, wherein the substrate provides the mechanical stability. Thus, the requirements for the surface can be separated from the mechanical requirements, and thus a plurality of advantages result with respect to efficiency, costs, weight, and the like.

In this case, the requirements for the surface of such plate material not only include optical requirements with respect to an optical and visual impression to be achieved, but rather also haptic properties and in particular also abrasion strength and resistivity. In this case, the first-mentioned properties should not only include properties that can be detected by touch, but rather also the properties of the surface structure in general. The last-mentioned properties relate overall to wear due to utilisation of the plate material, i.e. for example also wear due to use of the plate material, in particular in the form of or as part of a flooring.

The above-mentioned aims cannot always all be achieved together to a satisfactory extent. In particular, the provision of high-quality patterns with satisfactory resistivity and acceptable production costs is often a challenge. The object of the present invention is therefore that of providing a film for forming a plate material by applying the film to a decorative substrate, which combines high-quality decoration with high wear strength in cost-effective production. A further object of the present invention is that of providing a corresponding plate material, in particular in the form of a flooring element.

### SUMMARY

The mentioned objects are achieved by a film for forming a plate material by applying the film to a substrate, according to claim 1, and a plate material according to claim 16. Further advantageous embodiments of the present invention are specified in the dependent claims. According thereto, a film is provided for forming a plate material with a structured surface by applying the film to a decorative substrate, wherein the film comprises a wear protection group, comprising a connection layer which is designed to be connected to a decorative layer or decorative layer group, a transparent base layer on the connection layer, and a surface layer on the transparent base layer, a first lacquer layer on the surface layer of the wear protection group, wherein the first lacquer layer comprises an admixture of solid particles, and a second lacquer layer on the first lacquer layer, wherein the second lacquer layer comprises an admixture of silica particles.

Furthermore, a plate material is provided, which comprises a film according to any of the embodiments described herein, and a substrate consisting of a material of greater stiffness compared with the film.

### BRIEF DESCRIPTION OF THE FIGURES

Embodiments of the present invention will now be described in more detail with reference to the following figures. In this case, the corresponding illustration serves merely for improved understanding of the teaching according to the invention, and the advantages associated therewith, but should at no point be understood as limiting. In the figures:

FIGS. 1A & 1B schematically show the essential structure of films according to general embodiments of the present invention;

FIG. 2 schematically shows co-extrusion of a part of the film according to an embodiment of the present invention;

FIGS. 3A & 3B schematically show the formation of a plate material with a film according to an embodiment of the present invention; and

FIG. 4 shows a plate material in the form of flooring elements, which were manufactured from a plate material according to any of the described embodiments.

### DETAILED DESCRIPTION

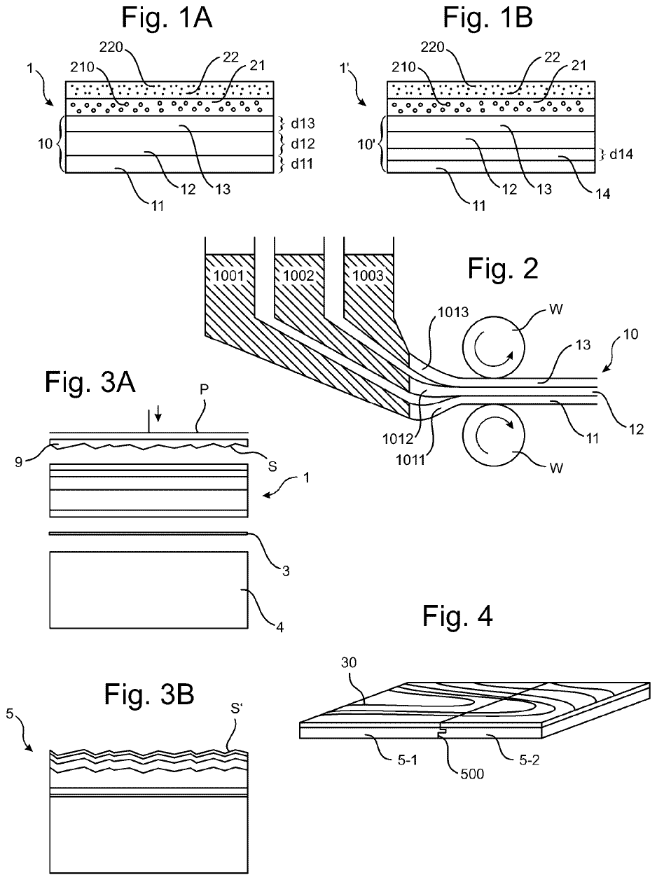

FIG. 1A schematically shows the essential structure of a film according to an embodiment of the present invention. According thereto, film 1 is provided for forming a plate material with a structured surface. In this case, the film 1 comprises a wear protection group 10 which a connection layer 11, a transparent base layer 12 on the connection layer 11, and a surface layer 13 on the transparent base layer 12. In this case, the surface layer 13 is preferably embossable, i.e. can be reshaped, in order to provide a substantial portion of the embossed surface layer of the finished product. The connection layer 11 is configured to be connected to a decorative layer or decorative layer group as set out in more detail below. In particular, said connection layer 11 can comprise a PP grafted with maleic anhydride, in order to allow for good adhesion to melamine resin(s), which can then advantageously be used as decorative supports.

The surface layer 13 thus provides, on the lacquer side, in particular good embossing capacity with different structures such as wood and stone, a good lacquering capacity, and already a substantial portion of the wear resistance. The PP block copolymers used as raw materials can ensure good durability of a corona pre-treatment here, in order to ensure good lacquering capacity and ultimately advantageous embossing of the surface. As a thermoplastic elastomer, the embossing of the surface can be significantly improved, since the raw material can be relatively soft compared with the other film and plate constituents. The surface layer 13 can preferably be provided with a UV stabiliser, in order to also withstand the UV exposure occurring in the inner region. This can in particular prevent, or at least noticeably delay, yellowing or embrittling. Furthermore, the surface layer 13 can be provided with an antiblocking additive, for avoiding blocking in the case of winding during transport and/or processing.

In this case, the transparent base layer 12 can in particular again provide a good embossing capacity with different structures, such as wood and stone, together with the surface layer 13. Moreover, the transparent base layer 12 can ensure good transparency, in order to thus achieve a good appearance of the decoration located therebelow. This means that the transparent base layer 12 in particular supports the decorative image particularly well towards the outside. Furthermore, the transparent base layer 12 can contribute, with relatively high toughness, to the film 1 overall withstanding the pressing process (cf. FIGS. 3A & 3B). Random, block and homo-PP-copolymers can be used as raw materials for the good embossing capacity and the good transparency and toughness. Furthermore, an elastomer can be added, in order to further increase the embossing capacity. The transparent base layer 12 can preferably comprise a combination of a UV stabiliser and a UV absorber, in order to both protect the film 1 per se from yellowing and embrittling, and, with the UV absorber, to protect the printed image under the film 1 from UV radiation. In embodiments in which protection of the decoration is not desired or not necessary, a pure UV stabiliser may also be provided in the transparent base layer 12.

The wear protection group 10 is preferably a co-extruded film structure, in which the connection layer 11, the transparent base layer 12 and the surface layer 13 are assembled in one process step from the respective base melt. This means that the connection layer 11 is assembled from a first starting granulate 1001, the transparent base layer 12 from a second starting granulate 1002, and the surface layer 13 from a third starting granulate 1003, in each case by melting and merging the melts in a roller assembly (see also FIG. 2). In this case, the connection layer 11 can in particular consist of, as an adhesion promoter layer, a maleic anhydride-grafted polypropylene (PP), which allows for particularly favourable adhesion to a decorative element or layer, e.g. in the form of a melamine resin paper, in the later production and finishing process.

In this case, the respective layer thicknesses d11, d12 and d13 are advantageously flexibly selectable and can thus be adapted to the respective application. In general, however, the layer thickness d12 of the transparent base layer 12 can be greater than the layer thickness d11 of the connection layer 11 and the layer thickness d13 of the surface layer 13. In this case, it may be advantageous if d11<2×d12 and d13<2×d12. For example, the following ranges can be specified for the respective layer thicknesses, which ranges provide an advantageous solution in particular in an application for a flooring element: 1000 μm<d11 1000 μm, 1000 μm<d12 1000 μm and 1000 μm<d13 1000 μm.

The film 1 further comprises a first lacquer layer 21 on the surface layer 12 of the wear protection group 10, the first lacquer layer 21 comprising an admixture of solid particles 210. Furthermore, the film 1 comprises a second lacquer layer 22 on the first lacquer layer 21, the second lacquer layer 22 comprising an admixture of silica particles 220. The lacquer layers 21, 22, which are applied to the wear protection group 10, can, in themselves, each also be provided in a multi-layer structure, such that the first lacquer 21 and/or the second lacquer 21 are applied in one or more layers, according to desired properties in each case. In general, a single lacquer layer can have an area density of more than 15 g/m². The solid particles can comprise corundum and can preferably have an average diameter in a range of 2 μm to 20 μm, more preferably 3 μm to 19 μm. The silica particles can have an average diameter in a range of 2 μm to 20 μm, more preferably 3 μm to 19 μm. For enhancing resistivity against scratching there can be employed apart from, and/or in addition to, corundum also boron nitride, chromium oxide, glass beads and/or silicium carbide (SiC).

According to one embodiment, the first lacquer 21 is applied and pre-cured/fixed by means of a UV emitter, but not completely cured in the process, in order to improve the adhesion with the second lacquer 22 applied thereto. This second lacquer 22 is then applied to the first lacquer 21. Thereafter, the film blank can first be moved through a PAC station that is known per se, it being possible for the second lacquer 22 to be pre-set. This pre-setting makes it possible for the folding depth in the subsequent curing to be influenced by an excimer station, which is also known per se. This treatment using the excimer station can lead to folding of the lacquer surface, it being possible for a matte visual appearance and particularly good scratch resistance in the surface to be achieved. In this case, the latter can also be improved compared with an admixture with additional solid particles, i.e. particles consisting of a solid other than silica 222. A subsequent curing of the lacquer construction 21, 22 can take place by irradiation with UV light.

The particular feature of the construction produced in this way is in particular an improved resistance to scratches and/or chemicals, and in the process having a matte appearance. Furthermore, this construction can be structured particularly well, not only in one work step together with the formation of the plate material, but rather also while obtaining the matte surface appearance. Further details in this respect are set out in connection with FIGS. 3A & 3B. In general, the first lacquer 21 can comprise a 100% system of a UV-curing acrylate lacquer having solid particles 210 of for example corundum. The particle size of the solid particles 210 can be larger than 10 μm. The second lacquer 22 can comprise a 100% system of a UV-curing acrylate lacquer without solid particles, such as corundum, but with silica particles 220. The particle size of the silica particle 220 can be smaller than 10 μm.

In general, the materials of the film 1 can be selected in such a way that they withstand further processing, in particular pressing with a substrate to form a plate material, at temperatures of >160° C. Possible formulas for the starting material are therefore based on, i.e. contain, inter alia tough block PP copolymers and homo PP polymers, and mixtures thereof. Furthermore, random PP polymers and/or thermoplastic elastomers can be used. Such temperatures may then be required in particular if curing of a decorative element or decorative layer of the plate material is intended to take place. The mentioned temperatures therefore advantageously also allow for curing of a melamine resin-based decorative layer for forming a particularly high-quality plate material. Furthermore, these properties allow for processing in acceptable or even constant cycle times.

FIG. 1B schematically shows the essential structure of a film according to an embodiment of the present invention. According thereto, film 1′ is provided, which initially comprises the same elements as the film 1 from FIG. 1A. What has just been stated also applies correspondingly for the film 1′, which additionally comprises a fourth additional layer 14 between the connection layer 11 and the transparent base layer 12. This additional layer can further improve the embossing capacity and optionally also the spectrum of the possible structures, for example wood and stone, with still improved properties with respect to wear and transparency. The additional layer 14 can in particular retain a greater embossing depth during the pressing process, due to a corresponding additional layer thickness d14 in a range of 5 μm to 50 μm, such that the end product withstands this production process and can provide more realistic structures. Random, block and/or homo PP copolymers can be used as raw materials for a good embossing capacity and good transparency and toughness. Preferably, the toughness/hardness of the additional layer 14 is increased compared with the transparent base layer 12 and/or the surface layer 13, in order to also retain a relatively large embossing depth in a stepwise manner, i.e. layer by layer, without the adhesion properties of the connection layer 11 being negatively influenced.

Furthermore, an elastomer can also be used as a raw material, in order to further increase the embossing capacity. Furthermore, the additional layer 14 can also comprise a UV stabiliser, a UV absorber, or a combination thereof, in order to both protect the film 1′ per se from yellowing and embrittling, and to protect the printed image under the film 1′ from UV radiation (UV absorber).

In general, the films 1, 1′ or one or more layers of the layers 11-14 can comprise an antistatic additive, in order to advantageously simplify the separation process or feeding into a processing machine (e.g. press). As well as a permanent antistatic agent, a migrating system or a slip additive can also be used. In a further embodiment in this respect, in the layer structure the connection layer is already provided with a structure upwards, i.e. in the direction of the following layers 12 or 14, 13, etc., this structure also continuing upwards before the embossing, such that the so-called glass plate effect can be effectively prevented, within the meaning of improved separation and processing. Furthermore, a suitable flame retardant can be added to the mentioned lacquer layers and/or film layers.

FIG. 2 schematically shows co-extrusion of a part 10, 10′ of the film 1, 1′ according to an embodiment of the present invention. According thereto, the corresponding melts 1011, 1021, 1031 are created from raw materials 1001, 1002, 1003, i.e. granulates of the mentioned materials and substance combinations, and processed in a rolling mill W, in one step, to form the film 1. This results in the film 10, 10′ with the connection layer 11 from the melt 1011, the transparent base layer 12 from the melt 1012, and the surface layer 13 from the melt 1013. In order to produce a four-layer or multi-layer structure, the corresponding additional melts are fed to a corresponding position, i.e. for example one melt for an additional layer 14 between the connection layer 11 and the transparent base layer 12.

FIGS. 3A & 3B schematically show the formation of a plate material with a film according to an embodiment of the present invention. According thereto, a film 1 (or 1′), a decorative layer 3 for example in the form of a printed and therefore decoration-bearing melamine resin paper, and a substrate 3, are stacked. An embossing tool 9 having a structure S is laid on this stack, and then pressed using a press or short-cycle press P under the action of pressure and optionally heat. In this way, a plate material 5 having a correspondingly structured surface S′ can be formed by applying the film 1, 1′ on a decorative substrate 3, 4, as shown in FIG. 3B. In one example, a film 1 is reshaped in the press P using a pressing plate 9, introducing a wood, stone or another structure. In this case, the end product particularly advantageously maintains a matte appearance. The retrospective reshaping of the already cured lacquers makes it possible for much better results to be achieved in terms of scratch resistance, compared with an embossed film in which the lacquer is then applied to the structure.

FIG. 4 shows a plate material in the form of flooring elements 5-1, 5-2, which were manufactured from a plate material according to any of the described embodiments. As a flooring element, the plate material 5-1, 5-2 should provide a corresponding visual and haptic impression 30, which is provided in particular by the embossed film 1, 1′. Furthermore, the flooring elements 5-1, 5-2 can comprise tongue and groove or other fastening elements 500, in order to in particular provide an entire floor surface comprising the plate material according to an embodiment of the present invention. FIG. 4 thus shows an embodiment with a so-called click connection. A plate material according to the invention can, however, also be configured as flexible roll goods for adhesive bonding (without a click system).

In general, the embodiments of the present invention can therefore provide a transparent and smooth wear layer of PP, a co-extruded three-layer or four-layer structure subsequently being finished with two or more lacquer layers, using a lacquer application facility, preferably within a machine run. Subsequently, the semi-finished product can be cut, stacked, repackaged and transported for further processing, in order to be pressed with a coated support plate, with the aid of a (short-cycle) press. A printed melamine resin paper or a transparent melamine resin intermediate layer can be located between said support plate and the film. In a concluding step, individual elements, such as the flooring element shown in FIG. 4, can be produced from a plate of corresponding size. The present invention also in particular makes it possible to produce flooring having a PP/plastics material cover layer (design flooring) in a (short-cycle) press, instead of the melamine resin overlays (laminate flooring) used hitherto. In this case, the conventional machinery can still be used, in particular the widely used short-cycle presses. The floorings obtained in this way can achieve several of the advantageous properties of laminate floorings, and add yet further advantages from the plastics wear layer, for example in the form of the film 1, 1′. A warm and soft feeling on the feet and less impact noise can be cited as further advantages. Furthermore, an opaque film can result in a furniture component such as a kitchen body. An opaque film of this kind can also be printed with a decoration before lacquering.

The described embodiments are intended to serve in general only for improved understanding of the present invention. In particular, however, this description is not intended to limit the scope of protection, which is determined only by the independent claims.

1. A film for forming a plate material with a structured surface by applying the film to a decorative substrate, wherein the film comprises:
a wear protection group, comprising a connection layer which is designed to be connected to a decorative layer or decorative layer group, a transparent base layer on the connection layer, and a surface layer on the transparent base layer;
a first lacquer layer on the surface layer of the wear protection group, wherein the first lacquer layer comprises an admixture of solid particles; and
a second lacquer layer on the first lacquer layer, wherein the second lacquer layer comprises an admixture of silica particles.

2. The film according to claim 1, wherein the solid particles comprise corundum.

3. The film according to claim 1, wherein the silica particles have an average diameter in a range of 2 μm to 20 μm.

4. The film according to claim 1, wherein the transparent base layer of the wear protection group has an embossing.

5. The film according to claim 1, wherein the connection layer of the decorative layer group comprises a block copolymer, random copolymer, terpolymer or elastomer, at least in part.

6. The film according to claim 1, wherein the decorative base layer of the decorative layer group comprises a polyolefin-based plastics material, at least in part.

7. The film according to claim 6, wherein the decorative base layer comprises a coloring component.

8. The film according to claim 1, wherein the decorative support layer of the decorative layer group comprises a block copolymer and/or PP homopolymer, in part, or completely.

9. The film according to claim 1, wherein the decorative layer comprises a colorant in a casein-based, polyurethane-based or acryl-based binder, and the decorative layer is applied as a water-based and/or organic solvent-based color system in conventional printing methods.

10. The film according to claim 1, wherein the further connection layer of the wear protection group comprises a thermoplastic elastomer, a polyolefin-based plastics material, polypropylene and/or polyethylene.

11. The film according to claim 10, wherein the further connection layer comprises an adhesion promoter.

12. The film according to claim 1, wherein the transparent base layer of the wear protection group comprises a random copolymer, in part, or completely.

13. The film according to claim 1, wherein the base layer of the wear protection group is soft compared with the surface layer.

14. plate material, comprising a film according to claim 1 and a substrate consisting of a material of greater stiffness compared with the film.

15. The film according to claim 2, wherein the solid particles have an average diameter in a range of 2 μm to 20 μm

16. The film according to claim 4, wherein the edges of the embossing have a flexion radius of at least 10 μm.

17. The film according to claim 6, wherein the decorative base layer of the polyolefin-based plastics material comprises polypropylene.

18. The film according to claim 9, wherein the conventional printing methods comprise intaglio printing or digital printing.

19. The film according to claim 11, wherein the adhesion promoter comprises maleic anhydride-grafted polypropylene.

20. The film according to claim 13, wherein the base layer of the wear protection group comprises an elastomer.
